(19) United States
(12) Patent Application Publication
(10) Pub. No.: US 2002/0128333 A1
(43) Pub. Date: Sep. 12, 2002

(54) Low switching temperature polymer positive temperature coefficient device

(76) Inventors: Ho Yin Tang, Kowloon (HK); Sidharta Wiryana, Kowloon (HK)

Correspondence Address: CHRISTIE, PARKER & HALE, LLP, 350 WEST COLORADO BOULEVARD, SUITE 500, PASADENA, CA, 91105, US

(21) Appl. No.: 09/886,625

(22) Filed: Jun. 20, 2001

Related U.S. Application Data
(60) Provisional application No. 60/213,357, filed on Jun. 20, 2000.

(51) Int. Cl. C08J 5/20

(52) U.S. Cl. 521/25; 428/458

(57) ABSTRACT

A low switching temperature PTC device. The device includes a polymeric compound including a low melting temperature polyethylene, a plasticizer, and two types of carbon black.

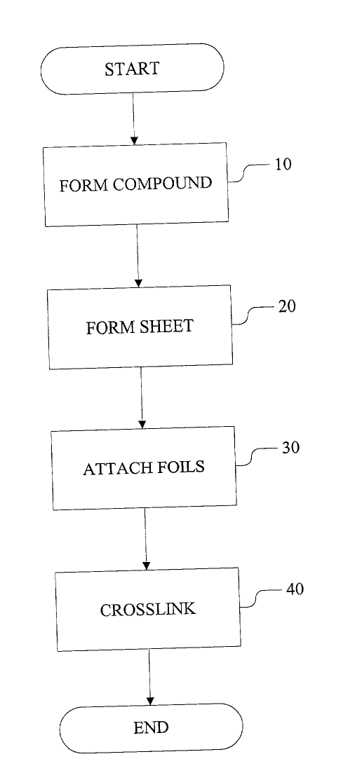

### CROSS-REFERENCE TO RELATED APPLICATION(S)

This application claims the benefit of the filing date of U.S. Provisional Patent Application No. 60/213,357, entitled 70° C. Temperature Switch PPTC, the disclosure of which is incorporated by reference herein.

### BACKGROUND OF THE INVENTION

The present invention relates generally to conductive polymer positive temperature coefficient (PTC) devices, and more specifically to conductive polymer PTC devices having low switching temperature ranges.

Conductive polymer PTC devices are used in a variety of applications. These applications include self-regulating heater applications, circuit protection applications for electronic devices, and other applications. Conductive polymer PTC devices, particularly in circuit protection applications, have very low resistance at low temperatures, but very high resistance at high temperatures. Moreover, often such devices change from a low resistance state to a high resistance state in a narrow temperature range. The temperature range is generally sufficiently narrow for the device to be considered to having a switching temperature, below which the device is of low resistance and above which the device is of high resistance.

When used as over current protection devices, conductive polymer PTC devices provide several beneficial qualities. The devices may achieve high temperatures when, for example, excessive current is attempted to be drawn through the device. The high temperature causes the device to enter a high resistance state, which may often be considered substantially non-conductive. In addition, once the temperature of the device falls within acceptable limits, the device once again becomes conductive. The device therefore acts in many aspects as a resettable fuse. Thus, polymer PTC devices are often used to protect sensitive or valuable semiconductor devices and chips, and other electrical equipment.

In some applications, it is desirable to have switching temperature of the device be at a relatively low temperature. For example, in some instances it is preferred that the device switch at a temperature of less than 100° C., sometimes preferably less than 85° C., and sometimes even more preferably approximate or below 70° C. The switching temperatures are beneficial in that such devices are often easier to trip, or place into a largely non-conductive state, and thereby provide increased protection for, for example, the voltage or low current devices.

In addition, it is often desirable to minimize the effective surface area or footprint of the device. Such situation may occur, for example, in surface mount applications in which the area utilized by the device on a circuit board or other substrate is reduced. In general, the resistivity of the device is proportional to the volume resistivity of the resistive material homing device. Decreasing the volume resistivity of the device, therefore, allows for benefits, including that of allowing for devices of smaller volumes.

### SUMMARY OF THE INVENTION

The present invention provides a low switching temperature and low volume resistivity polymer positive temperature coefficient device.

In one embodiment, the present invention comprises a semi-crystalline polymer, a plasticizer, and conductive particles. In one embodiment, the present invention comprises a low melting point semi-crystalline polymer, which is loaded with approximately 10% plasticizer and greater than 5%, and preferably greater than 50% carbon black.

These and other aspects of the present invention will be more readily understood in view of the following figure and detailed description.

### BRIEF DESCRIPTION OF THE DRAWING

The FIGURE is a flow diagram of a process for forming devices in accordance with the present invention.

### DETAILED DESCRIPTION

The FIGURE illustrates a process of forming devices in accordance with the present invention. In block 10, a compound is formed, the compound being a polymeric compound exhibiting a PTC effect. The components are batch mixed or compounded, which may be accomplished using for example, a single extruder or a twin screw extruder, or through other generally known techniques for mixing or compounding polymeric mixtures or compounds used in PTC devices. In block 20, a sheet of conductive polymer material is formed. The conductive polymer material is comprised of the polymeric compound. In block 30, the conductive polymer is material pressed between two conductive nodular copper nickel foils to form a laminate. In block 40, the polymeric compound is crosslinked. Crosslinking may occur via thermal treatment, through chemical processes, or via irradiation. In one embodiment, the polymeric compound is crosslinked using about 5 Mrad irradiation after the foil has been attached to the polymeric compound. The foil is preferably modular foil to increase adhesion to the polymeric compound.

The process therefore forms a laminar PTC device. The laminar PTC device, when viewed in cross-section, includes a first foil and a second foil sandwiching a polymeric conductive compound.

The polymer compound is comprised of a semi-crystalline polymer plasticizer, and conductive particles. In one embodiment, the semi-crystalline polymer is an ethylene, and in one embodiment the semi-crystalline polymer is comprised a low density polyethylene (LDPE) or a mixture of a LDPE and a high density polyethylene (HDPE). In some applications, the polymeric compound may also include fire retardant agents, arc suppressant agents, crosslinking agents and other additives commonly known or used in polymeric positive temperature coefficient devices.

In one embodiment, the plasticizer is a micronized polyester wax.

In one embodiment, the conductive particles are carbon blacks. In one embodiment, the conductive particles are a mixture of two carbon blacks.

In various embodiments, the proportions by volume of the semi-crystalline polymers varies from 30-50%, and is preferably approximate 40%. The plasticizer is preferably between 5-15% by volume, and more preferably approximate 10% by volume. The carbon black totals preferably greater than 5% by volume, and more preferably 30% by volume, and most preferably approximately 50% by volume. In several embodiments, the carbon black is composed of two types of carbon black, with substantially most of the carbon black being of one type.

The following table provides sample formulations of the components of the polymeric compound:

| Polymer | Plasticizer | Carbon Black | Carbon Black |
|---|---|---|---|
| TC020 | Ceridust 5551 | Huber N-787 | Vulcan XC72R |
| 3.9/10 | 1/10 | 5.0745/10 | 0.0255/10 |
| TC020 | Ceridust 5551 | Huber N-787 | BP2000 (2X.HT) |
| 3.9/10 | 1/10 | 5.0745/10 | 0.0255/10 |
| Lotryl 7BA01 | Ceridust 5551 | Huber N-787 | Vulcan XC72R |
| 3.9/10 | 1/10 | 5.0745/10 | 0.0255/10 |
| Escor 5000 | Ceridust 5551 | Huber N-787 | Vulcan XC72R |
| 3.9/10 | 1/10 | 5.0745/10 | 0.0255/10 |
| Escor 5000 | Ceridust 5551 | Huber N-787 | BP2000 (2X.HT) |
| 3.9/10 | 1/10 | 5.0745/10 | 0.0255/10 |
| DQDA 6479 | Ceridust 5551 | Huber N-787 | Vulcan XC72R |
| 3.9/10 | 1/10 | 5.0745/10 | 0.0255/10 |
| TC020 | Ceridust 5551 | Tokai G-SVH | BP2000 (2X.HT) |
| 4.15/10 | 1/10 | 4.825/10 | 0.02425/10 |
| Escor 5000 | Ceridust 5551 | Tokai G-SVH | BP2000 (2X.HT) |
| 4.15/10 | 1/10 | 4.825/10 | 0.02425/10 |

For the above table, the components are listed by fraction. TC020 is an Ethylene Methyl Acrylate supplied by ExxonMobil Chemical under the tradename Optema TC020, Lotryl 7BA01 is an Ethylene Butyl Acrylate supplied by Elf Atochem under the tradename Lotryl 7BA01, Escor 5000 is an Ethylene Acrylic Acid supplied by Exxon Mobil Chemical under the tradename Escor 5000, and DQDA 6479 is an Ethylene Vinyl Acetate supplied by Union Carbide Corporation under the tradename DQDA 6479. Ceridust 5551 is a micronized polyester wax supplied by Clariant China Ltd. Huber N-787 is a carbon black supplied by J. M. Huber Corporation, Tokai G-SVH is a carbon black supplied by Tokai Carbon Co. Ltd., Vulcan XC72R is a carbon black supplied by Cabot Corporation, and BP2000 is a carbon black Black Pearl 2000 supplied by Cabot Corporation.

It has been found that devices of such compositions have low room temperature resistivities and a switching temperature approximate 70 degrees Celsius.

The present invention therefore provides a polymeric positive temperature coefficient device. Although the invention has been described in certain specific embodiments, it should be realized that the scope of the invention is the claims supported by this document in view of that known to those of skill in the art, and the equivalents of those claims.

What is claimed is:

1. In positive coefficient temperature device a laminar polymeric compound comprised of a semi-crystalline polymer, a plasticizer, and conductive particles.

2. The laminar polymeric compound of claim 1 wherein the plasticizer is approximately 10 percent of the polymeric compound.

3. The laminar polymeric compound of claim 1 wherein the semi-crystalline polymer is an ethylene, the conductive particles are carbon black, and the plasticizer is a micronized polyester wax.

4. The laminar polymeric compound of claim 1 wherein the conductive particles are comprised of two different carbon blacks and the semi-crystalline polymer is a low density polyethylene.

5. A positive coefficient device adapted for use in circuit protection, the device comprising:
a first laminar foil;
a second laminar foil;
a polymeric compound between the first laminar foil and the second laminar foil, the polymeric compound comprising a polymer, a plasticizer, and conductive particles.

6. The positive coefficient device of claim 5 wherein the polymer comprises a semi-crystalline polymer.

7. The positive coefficient device of claim 5 wherein the plasticizer comprises approximately ten percent of the polymeric compound and the conductive particles comprises two different carbon blacks.

8. The positive coefficient device of claim 5 wherein the device has a switching temperature of approximate 70 degree Celsius.

9. A method of forming a low switching temperature polymeric positive temperature coefficient device suitable for circuit protection use, the method comprising:
compounding semi-crystalline polymer, plasticizer, and carbon black to form a polymeric compound;
pressing the polymeric compound between nodular foil; and
crosslinking the polymeric compound.
